(19) United States
(12) Patent Application Publication
(10) Pub. No.: US 2010/0270245 A1
(43) Pub. Date: Oct. 28, 2010

(54) LIQUID SEPARATING DEVICE FOR THE SEPARATION OF A LIQUID MIXTURE

(75) Inventor: Peter Willem de Voogt, Brielle (NL)

Correspondence Address: HOFFMANN & BARON, LLP, 6900 JERICHO TURNPIKE, SYOSSET, NY, 11791, US

(73) Assignee: PLASTIC TEST INSTITUTE NETHERLANDS B.V., Stellendam (NL)

(21) Appl. No.: 12/743,431

(22) PCT Filed: Nov. 28, 2008
(86) PCT No.: PCT/NL2008/000262

§ 371 Date: Jun. 15, 2010

(30) Foreign Application Priority Data
Nov. 29, 2007 (NL) 1034778
Nov. 29, 2007 (NL) 1034779

(51) Int. Cl. B01D 17/038; B01D 35/00; B01D 35/157; B23P 19/00; B23P 11/00

(52) U.S. Cl. 210/787; 210/94; 210/232; 210/512.3; 29/426.3; 29/428

(57) ABSTRACT

A liquid separating device for the separation of a liquid mixture that at least comprises two liquids with a different density and possibly one or more solid substances comprising a conduit for the separation therein of the liquids of a liquid mixture that flows through the conduit and a swirl device for generating swirls in the liquid mixture in such a way that two liquid flows are created where a first liquid flow will concentrate in the centre of the conduit and a second liquid flow will move concentrically around the first liquid flow and where the swirl device comprises a motor that is positioned outside the conduit, a swirling element that is positioned in the conduit and a drive shaft that connects the motor and the swirling element to each other characterized in that the swirl device can be removed and that an opening has been provided in a wall of the conduit for the swirling element to pass through.

### CROSS-REFERENCE TO RELATED APPLICATIONS

This application is the National Stage of International Application No. PCT/NL2008/000262, filed Nov. 28, 2008, which claims the benefit of Netherlands Application Nos. NL 1034778, filed Nov. 29, 2007 and NL 1034779, filed Nov. 29, 2007, the contents of which are incorporated by reference herein.

### FIELD OF THE INVENTION

The invention relates to a liquid separating device for the separation of a liquid mixture that at least comprises two liquids with a different density and possibly one or more solid substances.

In particular, the invention relates to the separation of a liquid mixture of, for example, water or seawater contaminated by a liquid with a lower density, for example, oil.

### BACKGROUND OF THE INVENTION

When digging oil, it is not just oil that is being pumped up but often (also) (sea)water that may have been contaminated with oil, sand or other solid substances. The oil, the water and any solid substances must be separated from each other so that both the liquids and any solid substances can be further processed or returned.

The separation of these liquids, generally, takes place in a conduit where the two liquids flow through a liquid flow and swirls are generated in this liquid flow which means that the liquid with a higher density moves more to the side and the liquid with a lower density moves more to the centre. Examples of such installations have been published in US2003/0006188, U.S. Pat. No. 5,904,840 and U.S. Pat. No. 4,478,712.

A liquid separator is shown in U.S. Pat. No. 4,478,712 that separates the different liquids from each other in two or more steps. These liquids are separated from each other by using the difference in density of the liquids. By generating swirls in the liquid flow, the liquids with a higher density move more to the side of the conduit and the liquids with a lower density concentrate more around the longitudinal centre line of the conduit. The different, separated liquids are discharged using conduit components with a smaller diameter than the main conduit.

The swirls in the liquid flow are generated with one or more rotors that comprise blades that turn around in the liquid flow. The rotors are driven by a drive shaft, which is connected to a motor. Said motor has been set up outside in the extension of the conduit and downstream.

In this setup the drive shaft goes through one or more conduit components, which have been positioned downstream in the liquid flow. A seal has been positioned at each transection of a conduit component. In, for example, U.S. Pat. No. 447' and other liquid separating devices, the shaft of the rotors rotates at a high speed in the seal which means that the rubbing speeds in the seal are also high. This means that wear and tear always occurs quickly with regard to the seal. It has also emerged that the known liquid separating devices again cause problems due to the high sensitivity to wear damage of the liquid separating device.

### SUMMARY OF THE INVENTION

The present invention has the object to at least partially overcoming at least one of the abovementioned disadvantages and/or to provide a useful alternative. In particular, the invention aims to provide a liquid separating device for the separation of a liquid mixture comprising at least two liquids with different densities and possibly one or more solid substances with a reduced risk of wear to the seals or bearings and simple and fast replacement of a leaking seal.

Said object is achieved with a liquid separating device for the separation of a liquid mixture comprising at least two liquids with a different density and possibly one or more solid substances comprising a conduit for the separation therein of the liquids of a liquid mixture flowing through the conduit and a swirl device for the generation of swirls in the liquid mixture in such a way that two liquid flows are created where the first liquid flow is concentrated in the centre of the conduit and the second liquid flow moves concentrically around the first liquid flow and wherein the swirl device comprises a motor that is positioned outside the conduit, a swirling element that has been positioned in the conduit and a drive shaft that connects the motor and the swirling element with each other where the swirl device at least comprises one bearing system for the bearing connection of parts that rotate with regard to each other.

The liquid separating device in accordance with the invention is characterized in that each bearing system of the swirl device, in particular, the bearing system of the drive shaft, has been positioned outside the conduit. The advantage is that the conduit can, due to this, remain free from the bearings so that the risk of breakdown because of a failure of the bearings or seals is minimised. The advantage is that the liquid flows that often comprise highly abrasive components such as sand have nearly no influence on the operation of the bearing system due to the positioning of the bearing system outside the conduit. Excessive wear can be avoided with the liquid separating device so that the separation can take place reliably and durably.

By preference, the drive shaft is directly linked to the outward motor shaft of the motor. By preference, a transmission such as a cog belt disk transmission, will not take place. This means that the drive shaft can be directly provided with bearings on the bearing system of the motor shaft, which leads to the advantage of having a simple construction. The advantage is that the number of components is a minimum, which further limits the risk of breakdowns. Moreover, the bearing system of the motor shaft will remain protected in a motor frame which means that the risk of failure of the bearing system due to external corroding influences is small. The advantage is that the liquid separating device can also be deployed in a strongly corrosion-sensitive environment such as on a drilling platform.

In an advantageous version of the liquid separating device, the swirl device can be removed from the conduit where an opening has been provided in a wall of the conduit for passing the swirling element. This means that the liquid separating device can be easily disassembled, which is an advantage. A possible breakdown can be easily resolved and maintenance related to, for example, the replacement of a seal can be quickly performed due to this.

In a preferred version, in accordance with the invention, the conduit comprises a main component in which the swirling element is set up and a secondary section to which the motor frame has been fastened that can be removed. The advantage of this version lies in the fact that the motor can be fastened to the secondary section of the main component where fastening possibilities can be formed on the secondary section. The above version of the liquid separating device ensures that the burble device can be removed and moved so that the swirling element can be removed from the main component and the side piece and seals can be replaced.

In a preferred version, an end of the secondary section is equipped with a flange and the motor frame is equipped with a flange. The advantage of this is that the motor frame and an end of the secondary section can be interlinked in a way which means that there is less risk of the seal leaking. Moreover, the flange fastening has the advantage that this can be removed and fastened several times without losing reliability.

In a preferred version, use is made of a seal in-between the flange at the end of the secondary section and the flange on the motor frame with the advantage that the seal will provide a liquid-tight flange coupling.

In a preferred version, use is made of a seal around the drive shaft with the advantage that the liquid in the liquid separating device cannot reach the motor which means that the motor is protected.

In a preferred version, the swirling element is fastened on the drive shaft in a way that it can be removed with the advantage that the swirling element can be removed from the drive shaft after which the seal in-between the drive shaft and the motor can be easily replaced and/or the swirling element itself can be replaced.

In a preferred version, the drive shaft has been fastened on the motor in such a way that it can be removed with the advantage that the drive shaft can be removed from the motor after which the seal in-between the drive shaft and the motor can be easily replaced and/or the drive shaft itself can be replaced.

In a preferred version, the main component of the conduit has, mainly, been provided straight. By preference, the conduit will, mainly, have the same diameter with regard to the whole length. The advantage of this is that a conduit readily available in the trade can be used.

The conduit has been at least partially provided as a transparent conduit in a version of the liquid separating device in accordance with the invention. The advantage of this is that the separation process can be checked visually. An operator can easily see whether the separation process is taking place in the best possible manner. The conduit can be partially transparent through the presence of an inspection window but, by preference, the whole main component of the conduit should be transparent. The main component can, for example, be made of polycarbonate.

The separation process can be arranged in different ways. By preference, the speed (rotations per minute) of the motor can be adjusted. The flow speed of the liquid flows can be adjusted by setting the speed. By preference, at least one adjustable shut-off valve will have been provided where the shut-off valve is connected in the flow connection to the main component. The flow speed of the liquid flows can be easily and effectively controlled by adjusting the shut-off valve. By preference, the adjustable shut-off valve will be positioned downstream of the main component. It has emerged that with a downstream positioned adjustable shut-off valve, the separation process can be set more accurately.

In a version of the liquid separating device in accordance with the invention, a shut-off valve has been provided both upstream and downstream of the main component. The advantage of this is that maintenance can be easily carried out to, for example, the main component or the burble device by fully closing the valves.

In a special version, the main component of the conduit is provided conically and the drive shaft is provided hollow positioned in the main component and the hollow drive shaft is used as a discharge conduit for discharging the first or the second separated liquid flow, which concentrates around the longitudinal centre line of the main component.

In a preferred version, the secondary section is in the extension of the main component where a supply conduit, by preference, connects to the main component with a bend. This means that the drive shaft can consist of a straight shaft which means that fewer parts are required. The device will also be more reliable because fewer wear damage-sensitive parts such as a coupling in-between two shaft parts are required.

In a preferred version, the supply and discharge conduits of the main component have been set up to be connected to an existing conduit system with the advantage that the device can be used in existing situations and, therefore, can be broadly applied.

The invention also concerns a working method for the separation of a liquid mixture using a device as described above and connected to an existing conduit system.

The invention also concerns a working method for the replacement of the seal in-between the flanges or around a drive shaft using the option that the burble device can be removed and that an opening has been provided in a wall of the conduit to pass through the swirling element. First the burble device is removed from the side piece to replace the seal in-between the flanges. This is possible by removing the fastening in-between the flange on the side piece and the flange on the motor frame. Next, the burble device can be moved to a position where the swirling element is removed from the main component and the side piece. In this position, both flanges can be easily accessed and the seal can be replaced. After replacing the seal, the burble device can again be moved in such a way that the swirling element is again in the main component. Next, the flange of the motor frame can again be reconnected with the flange of the side piece to, thus, again create a liquid-tight connection.

The invention also concerns a working method for the replacement of the seal around the drive shaft using the device as described above and the characteristic that the swirling element can be removed from the drive shaft and that an opening has been provided in a wall of the conduit for the swirling element to pass through. First the burble device is removed from the side piece for the replacement of the shaft seal around the drive shaft. This is possible by removing the fastening in-between the flange on the side piece and the flange on the motor frame. Next, the burble device can be moved to a position where the swirling element is removed from the main component and the side piece. The next step is to remove the swirling element from the drive shaft and/or to remove the drive shaft from the motor. Next, the shaft seal around the drive shaft can be replaced. After the replacement of the shaft seal, the swirling element is repositioned on the drive shaft and/or the drive shaft is reconnected to the motor, after which the burble device is again moved in such a way that the swirling element is again in the main component. Next, the flange of the motor frame can again be reconnected with the flange of the side piece to, thus, again create a liquid-tight connection.

### BRIEF DESCRIPTION OF THE DRAWINGS

Further characteristics and advantages of the invention will be explained below based on the description of a preferred version given below where possible alternative versions will be specified. Reference is made to the attached drawings in the explanation. The following is shown:

FIG. 1 shows a cross section of a preferred version of a practical application of the liquid separating device in accordance with the invention;

FIG. 2 shows a cross section of a version of a practical application of the liquid separating device in accordance with the invention;

FIG. 3 shows a cross section of a version of part of the liquid separating device;

FIG. 4 shows a side-view of a preferred version of a practical application of the invention;

FIG. 5 provides a schematic representation of a pig launching and receiving assembly as is known from the state-of-the-art;

FIG. 6 provides a schematic representation of the pig launching and receiving assembly in accordance with the invention;

FIG. 7a provides a schematic representation of a launching station from FIG. 2;

FIG. 7b provides a schematic representation of a launching station with a forcing liquid as a launching medium;

FIG. 8 provides a schematic representation of the receiving station from FIG. 2; and

FIG. 9 provides a schematic representation of an underwater gas line with a launching station in accordance with the invention.

### DETAILED DESCRIPTION OF THE PREFERRED EMBODIMENTS

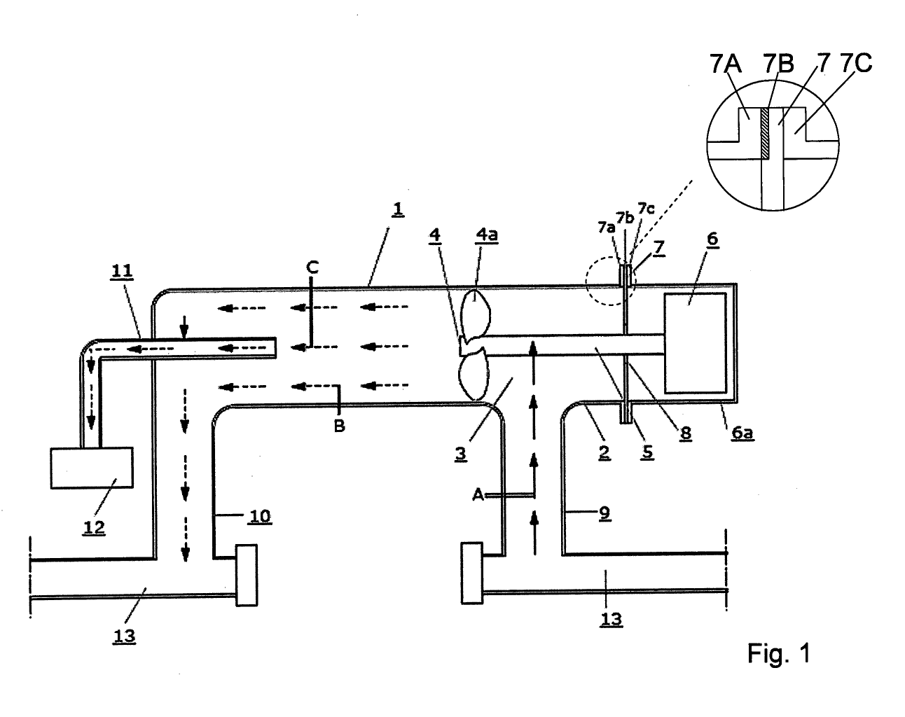

FIG. 1 shows a cross section of a version of a practical application of the liquid separating device in accordance with the invention where the liquid separating device comprises a main component referred to with reference number 1, a secondary section 2, a burble device 3 where the burble device 3 comprises a swirling element 4 with vanes 4a, for generating swirls in the liquid flow A, a drive shaft 5 for the connection of the swirling element 4 and the motor 6, a motor 6 for driving the swirling element 4, a motor frame 6A in which the motor 6 is positioned, a flange 7C on the motor frame 6A and flange 7A on the side piece 2 for the connection of the motor frame 6A to the side piece 2, a coupling 7 positioned in-between flange 7C and flange 7A with in here a seal 7B and a shaft seal 8 around the drive shaft 5, a liquid supply 9 with in here a liquid flow A, a liquid discharge 10 with in here a liquid flow B, a liquid discharge 11 with in here a liquid flow C, a liquid reservoir 12 for the storage of a separated liquid flow C and an existing conduit 13 on to which the liquid separating device has been connected.

In the shown version in FIG. 1, the main component 1 with piece 2 on this can be seen. A flange 7A has been formed on this side piece 2 for the fastening to another flange. Said other flange is formed by flange 7C, which is formed on an end of the motor frame 6A. A coupling 7 is positioned in-between flanges 7C and 7A. Said coupling 7 comprises a shaft seal 8 around the drive shaft 5. Said shaft seal 8 fully encloses the drive shaft 5 over a specific length of the drive shaft and ensures that liquid cannot leak through the drive shaft to the motor 6. The coupling 7 also has a seal 7B on the side of flange 7A, which provides a liquid-tight fastening of the flange 7A and the coupling 7.

The place of the motor frame 6A is determined by the coupling of the motor frame 6A through flanges 7C and 7A to the side piece 2. The location of the burble device 3 is also determined through the coupling of the motor frame 6A to the side piece 2 because the motor 6 is positioned in the motor frame 6A, which forms the burble device 3 together with the drive shaft 5 and the swirling element 4.

A liquid mixture A is supplied through a liquid supply conduit 9 for the separation of two liquids from a liquid mixture. The liquid supply conduit 9 is connected to an existing conduit system 13 and is supplied with the liquid mixture A from this existing conduit system 13. Said motor 6 must be switched on to start the liquid separating process. When the motor 6 is switched on, this will drive the drive shaft 5 which means that the swirling element 4 will start to run which means that the vanes 4A will also start to run. Swirls are created in that part of the liquid flow A that can be found in the main component because the vanes 4A are running. The two liquids present in the liquid mixture will behave differently due to the difference in density in-between the different (liquid) substances and the swirls in the liquid flow. The liquid with the lowest density, liquid flow C, will concentrate around the longitudinal centre line of the main component 1. The liquid from the liquid mixture with the greatest density, liquid flow B, will concentrate concentrically and more against the side wall of the main component.

Not only will swirls be created in the liquid flow due to the running of swirling element 4 but liquid flows B and C can also be pushed up in the direction of liquid discharges 10 and 11 where the liquid discharge 11 has been added for the discharge of the liquid flow C and liquid flow B, respectively. Said liquid discharge 11 is partially positioned inside and partially outside the conduit 1.

Liquid flow B is the main flow in this version and is discharged from the liquid separating device through the liquid discharge 10. Said liquid discharge 10 is also connected to an existing conduit system 13 which means that the separated liquid flow B can be discharged.

In an alternative version, the discharge conduit 11 can discharge the separated liquid C and liquid B, respectively, directly to a reservoir 12.

In another alternative version, the discharge conduit 11 can be connected to a conduit line which means that the separated liquid C and liquid B, respectively, can be conveyed to the required destination.

Swirling element 4 has, by preference, been equipped with two vanes 4A where the vanes have such a form that that the highest possible performance can be obtained in the shown version in FIG. 1. In an alternative version, the swirling element 4 can be provided with more than two vanes 4A, by preference, with 4 vanes where the vanes 4A are proportionally distributed over the circumference of drive shaft 5.

The swirling element 4 can be produced from different materials, for example, a stainless steel or bronze alloy. Any other corrosion-resistant and strong material is suitable to produce a swirling element.

The motor 6 in the shown version in FIG. 1 is, by preference, an electric motor. In an alternative version, other types of motors can also be used such as explosionproof electric motors, hydraulic motors or pneumatic motors.

A lot of water flows through the conduit during the liquid separating process. A volume flow rate can be achieved of, for example, 250 m3/h with regard to a 6-inch conduit or even a volume flow rate of 100 m3/h can be achieved with regard to a 4-inch conduit, which may cause damage to the environment and/or the motor should the liquid separating device leak. Seals are used to avoid leakage. The seal is formed in-between the connection of the motor frame 6A to the side piece 2 through flanges 7C and 7A through a coupling 7 with a seal 7B on the side of flange 7A in the shown version in FIG. 1. Said seal 7B has been clamped against flange 7A after flanges 7C and 7A have been fastened and provides a liquid-tight seal.

In an alternative version, the separation of the liquids and/or solid substances can be optimised through adjusting the speed of the burble device. Said speed can be adjusted through a frequency controller.

In another version, the speed can be adjusted through a multiple-pole electric motor that emits a speed set in advance in combination with a cam switch.

In an alternative version, a hydraulic or pneumatic motor can be used where the speed is determined by the quantity of supplied oil and/or air.

In an alternative version, two or more liquid separating devices can be positioned one in front of the other to separate the substances present in the liquid mixture from each other in different steps to ensure that the highest possible overall performance can be achieved.

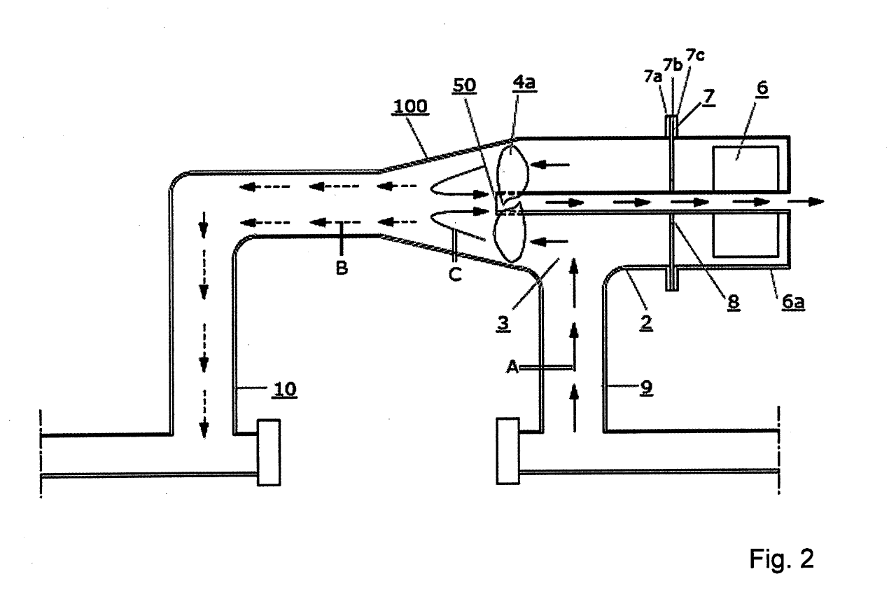

FIG. 2 shows a cross section of a version of the liquid separating device in accordance with the invention. Basically, the version of the liquid separating device shown in FIG. 2 is the same as the liquid separating device shown in FIG. 1. The difference between the versions in FIGS. 1 and 2 is formed by the difference in the main component 1 in FIG. 1 and the main component 100 in FIG. 2. The version as shown in FIG. 2 comprises a main component 100 which tapers conically. The liquid mixture A is supplied through a liquid supply conduit 9 for the separation of the liquids and any solid substances present from the liquid mixture A. The burble device 3 generates swirls in the liquid flow A which means that the substances with a different density will start to behave differently. Liquid C with a lower density will concentrate around the longitudinal centre line of the main component 100 and liquid B with the higher density will start to move concentrically around it along the wall of the main component 100. The separated liquids will initially move away from the burble device 3 due to said burble device 3. There is less space in the main component 100 for the liquids B and C due to the main component 100 tapering conically. Liquid C will start to move around the longitudinal centre line of main component 100 and liquid B will start to move concentrically around it against the wall of the main component 100 at the start of the main component 100 very close after the swirling element. The concentric movement of liquid B will push away liquid C that is moving around the centre line due to the reduced space further along in the main component 100. This means that liquid C that is moving around the centre line can only move in the opposite direction. Said liquid C will then move in the direction of the motor 6 and the burble device 3. Since said liquid is moving in the direction of the motor 6, it can be discharged through the hollow drive shaft 50.

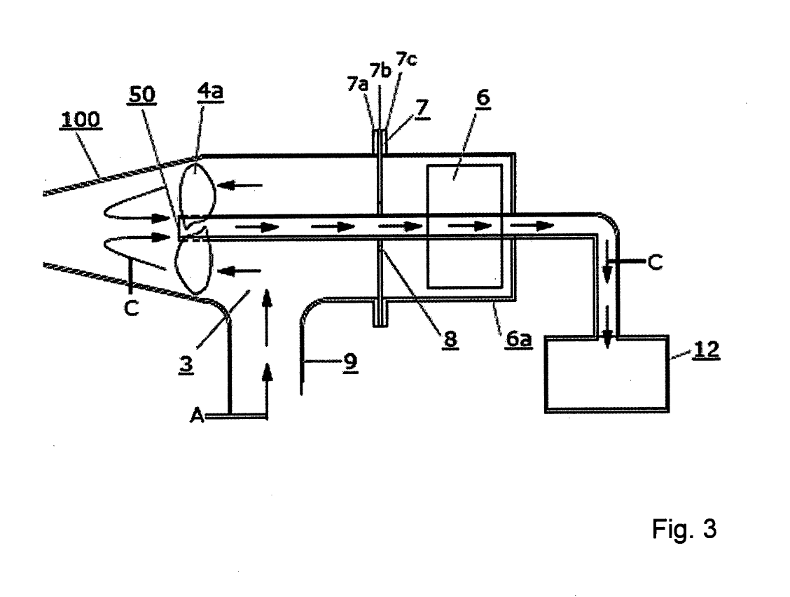

FIG. 3 shows a cross section of a version of a part of the liquid separating device. The version shown in FIG. 3 is basically the same as the liquid separating device shown in FIG. 2. The difference between the versions shown in FIGS. 2 and 3 is formed by the storage direction as described below and shown in FIG. 3.

The liquids and/or solid substances are separated through the burble device 3. Liquid C that is moving around the centre line will start to move in the direction of the motor due to the main component 100 tapering conically. The separated liquid is stored in the hollow drive shaft 50 and through said shaft it is discharged into reservoir 12.

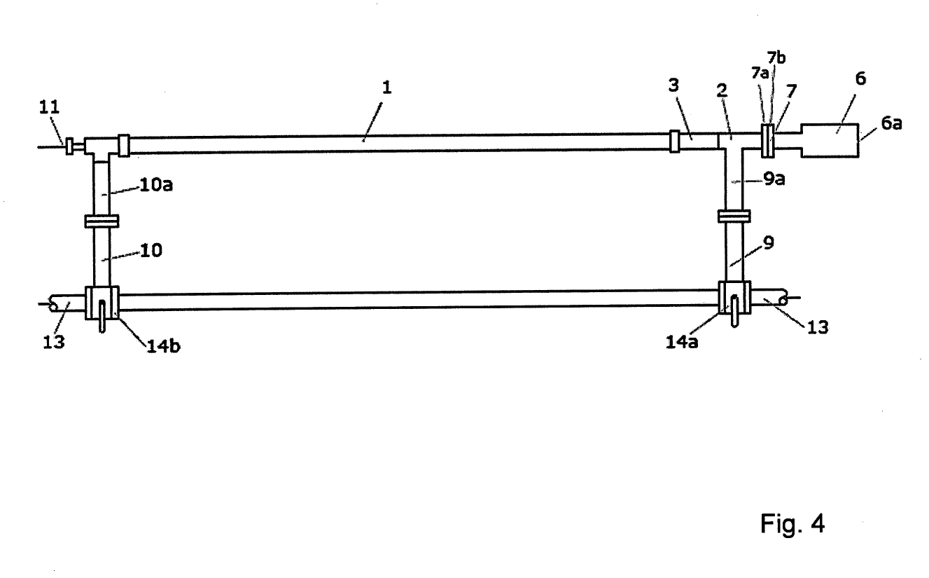

FIG. 4 shows a side-view of a practical application of the invention. The liquid separating device in FIG. 4 comprises a main component 1. Two T-pieces 9A and 10A are connected to this. The burble device 3 can be found in the horizontal part of the T-piece 9A. The secondary section 2 is formed by a horizontal part of the T-piece 9A that is not located in the main flow of the liquid mixture. A motor frame 6A is fastened to a horizontal part of the T-piece 9A, which also forms the secondary section 2. A motor 6 (not visible) has been positioned in this motor frame 6A. The motor 6 is connected to the swirling element 4 (not visible) through a drive shaft 5 and provides the drive for the swirling element 4. When the motor 6 is switched on, this will drive the drive shaft 5 (not visible) which means that swirling element 4 will start to run. This means that swirls are created in the liquid mixture A (not visible). The two liquids present in the liquid mixture A will start to behave differently because of these swirls. The liquid with the lowest density, liquid flow C (not visible), will concentrate around the longitudinal centre line of main component 1 and the liquid with the greatest density, liquid flow B (not visible), will concentrate concentrically and more against the side wall of the main component 1.

A liquid supply conduit 9 has been fastened to the vertical part of the T-piece 9A for the supply of the liquid mixture A. Said liquid supply conduit is connected to an existing conduit system 13 by using a 3-way shut-off valve 14A. Liquid discharge 11 has been added for the discharge of the separated liquid flow C and a liquid discharge 10 has been added for the discharge of the liquid flow B. Liquid discharge 10 is connected to an existing conduit system 13 through an adjustable shut-off valve 14B. The shut-off valve 14B can be adjusted manually. The flow of the shut-off valve 14B can be increased or reduced by turning the handle.

Liquid discharges 10 and 11 are both connected to a T-piece 10A. Said T-piece 10A is connected to main component 1 with a horizontal part. The use of the aforementioned T-pieces 9A and 10A has the advantage that these are existing parts. Standard parts can also be used for these T-pieces 9A and 10A so that in case of a disaster, parts can easily be replaced or repaired. This means that the liquid separating device can be easily applied making use of existing parts in an existing situation. The liquid separating device can be easily connected to an existing conduit system after which the liquid that flows through it can be separated and further processed. The liquid flow can be easily bypassed through the existing conduit system without flowing through the liquid separating device when a seal is worn. This will ensure that parts can be replaced and/or that maintenance can be carried out in this way.

Reference is made to liquid flow in the above text. The referred to liquid flow can consist of a liquid with inside another liquid. A liquid flow should also be understood to mean a liquid that at least partially comprises a solid substance such as a mud flow, slurry or a paste-like substance.

An invention has also been provided related to a working method for the discharge of a gas volume that has remained behind from a space of a main gas conduit and the application of the working method in a launching or receiving station for a pig (scraper).

The present invention relates to a working method for the discharge of a gas volume that has remained behind from a space of a main gas conduit such as a pig chamber. The gas volume is discharged through a gas discharge conduit. In practice, this takes place by blowing off the gas. This, however, creates other problems as will be explained below.

The invention also refers to a launching station for the introduction of a pig in a high pressure gas line comprising a pig chamber with a launching opening with inside a gas shut-off valve where the launching opening can be connected to the gas line.

The invention also relates to a receiving station for the removal of a pig from a high pressure gas line comprising a pig chamber with a receiving opening with inside a gas shut-off valve where the receiving opening can be connected to the gas line. The receiving station and the launching station together form a pig launching and receiving assembly for launching and receiving a pig in a gas line under high pressure.

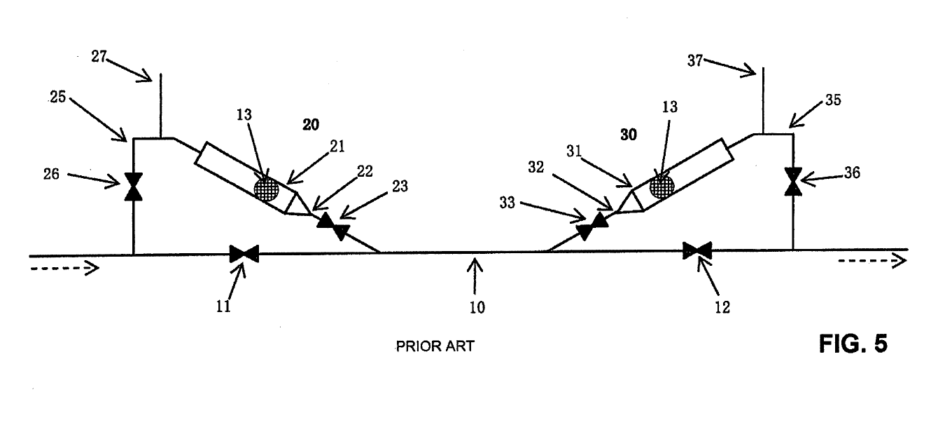

Such launching stations and receiving stations are known from the state-of-the-art for cleaning gas lines. It concerns here an industrial application where the gas lines convey a gaseous medium possibly together with a liquid medium under high pressure. FIG. 5 shows a launching and receiving assembly for launching and receiving a pig in a gas line that is known from the state-of-the-art. Two gas shut-off valves are included in the gas line. The first gas shut-off valve is located upstream and is positioned near a launching station. The second gas shut-off valve has been installed downstream near the receiving station. A bypass has been installed around the gas shut-off valves in the gas line in which the launching station or receiving station is included with a gas shut-off valve on both sides. When a pig must be launched or received, the related gas shut-off valve in the gas line is closed and the gas shut-off valves are opened. This means that the gas will start to flow down the bypass which means that the pig will be launched or received from the launching station or in the receiving station, respectively.

The launching station has a pig chamber. A pig can be added to the pig chamber. The pig is, for example, spherical and produced from a sturdy and difficult to deform material. The outer diameter of the pig matches the inner diameter of the gas line. The pig and the gas line, for example, have a twenty-inch diameter but at least a four-inch diameter. Pigs with a smaller diameter can also be used for reasons of safety and the environment. The diameter of the pig has a narrow fit when compared to the diameter of the gas line. When the pig is pushed through the gas line, liquids and any pollutants will be carried away with the pig and will be pressed out of the gas line to the receiving station. The pig can also be used for other objects such as, for example, the uniform distribution of a corrosion-inhibiting agent, that is, a corrosion inhibitor, on the inner wall of the gas line.

The term ‘pig chamber of the launching station or receiving station’ means the space in to which the pig is added before the pig is launched in the gas line. The term ‘pig chamber’ defines the position where the pig can be found before it is launched. The pig chamber can, for example, be a pressure vessel or part of a conduit.

The launching station with a pig chamber is included in the bypass around the first gas shut-off valve of the gas line. There is a launching opening on one of the sides of the pig chamber with inside a gas shut-off valve. A gas conduit can be found on the opposite side that has been equipped with a gas shut-off valve. The pig can be launched in the gas line by opening the gas shut-off valves in front and behind the pig chamber and closing the first gas shut-off valve in the gas line as is known from the state-of-the-art. The gaseous medium will now start to flow through the bypass and the launching station through the gas line. The pig will be conveyed to the gas line because the gaseous medium flows through the pig chamber. The first gas shut-off valve in the gas line will again be opened and the gas shut-off valves in the bypass will be closed after the pig has been launched. The pig will be taken by the gas flow to the receiving station.

A gas shut-off valve can be found in the gas line downstream from the receiving station that will be closed to send the pig to the receiving station. The gas will flow through the bypass in which the receiving station is included by opening the gas shut-off valves in front and behind the receiving opening of the receiving station and closing the gas shut-off valve in the gas line. When the pig is in the pig chamber of the receiving station, the gas shut-off valve in the gas line is again opened and the gas shut-off valves in front and behind the receiving opening is closed.

A gas volume will remain in the bypass under high pressure after closing the gas shut-off valves in the bypass because the gaseous medium flows under high pressure through the bypasses in which the launching and receiving stations can be found. Before a pig can again be added to the launching station or a pig can be removed from the receiving station, this gas volume will have to first be discharged. In practice, this takes place by blowing off the gas. This, however, creates other problems. First and foremost, blowing off gas means a waste that is also detrimental to the environment when, for example, it concerns natural gas. Various safety regulations must also be observed when blowing off gas under high pressure. A fire and explosion risk will, for example, be present with regard to flammable gases. This means that qualified staff will be required for blowing off the gas. A further disadvantage is that a quantity of gas will remain behind after blowing off. Post-purging will have to take place using a flushing gas to remove this gas. This means that blowing off gas is a laborious affair that must be performed with the required care whilst observing rules and regulations.

The present invention has the object of at least partially overcoming at least one of the abovementioned disadvantages and/or to provide a useful alternative. In particular, the invention has the aim to provide a working method, in particular, for a pig launching and receiving assembly where in emissions to the atmosphere and the risk of unsafe situations are reduced.

Said aim is achieved with a working method and the application thereof in a launching station in accordance with the invention for the introduction of a pig such as has been defined in clauses 1 and 6.

An advantage of the working method is that the blowing off of gas does not need to be performed. Characteristic of the launching station according to the invention is that the launching station is connected to a forcing liquid supply duct with a liquid pump for the supply of a forcing liquid in such a way that the gas can be dispelled from the pig chamber.

The gas volume that has remained behind in the space in-between the gas shut-off valves of the launching station can be easily discharged with the launching station in accordance with the invention in a safe manner. The space can be filled with liquid through the forcing liquid supply duct. The gas volume will be above the liquid level of the supplied liquid volume because it is lighter. The gas volume can be pushed up due to the continuously supplied forcing liquid and the liquid level raising. The gas volume will be discharged through a gas discharge conduit with a gas shut-off valve that is connected to the space of the launching station with the gas that has remained behind in a section that can be found on top. The gas volume can, for example, be discharged to a pressure vessel through the gas discharge conduit. However, by preference, the gas volume can be dispelled to the gas line through a gas return line. The advantage of this is that very little or no gas will be wasted.

In a special version of the launching station in accordance with the invention, the launching station has been connected to a forcing liquid supply duct that can be found on the other side of the launching opening of the pig chamber with a liquid pump for the supply of a forcing liquid. This means that the pig is pushable from the pig chamber due to the supply of forcing liquid and the pig can be launched into the gas line through the launching opening. The pressure that is exerted by the forcing liquid acts on one side of the pig and the gas pressure acts on the pig on the other opposite side. The gas is pressed by the pig because the liquid pressure is higher than the gas pressure and the pig can be launched into the gas line. Once the pig has been passed, the gas shut-off valve in the launching opening is closed and the forcing liquid can again be discharged. The use of a forcing liquid has the advantage that a bypass with the relevant gas shut-off valves and instrumentation does not need to be installed to push the pig into the launching system.

Moreover, it is an advantage that the launching station is purged clean at the same time as the forcing liquid is discharged. Thereafter, an additional step is no longer needed to purge the launching station. After the forcing liquid has been discharged, the next pig can be inserted in the pig chamber.

It is still possible to launch the pig from the launching station by using gas with this version of the launching station with the forcing liquid supply duct connected to the side opposite the launching opening. The position of the connection of the forcing liquid supply duct does not hamper the option to dispel the remaining gas by supplying forcing liquid after launching the pig through a gas discharge conduit in the top part of the launching station.

The aim of the invention is also achieved with a receiving station as defined in clause 9. Characteristic of the receiving station in accordance with the invention is that the receiving station is connected to a forcing liquid supply duct with a liquid pump for the supply of forcing liquid in such a way that the gas from the pig chamber can be dispelled.

The gas volume that has remained behind in the space in-between the gas shut-off valves of the receiving station can be easily discharged with the receiving station in accordance with the invention in a safe manner. The space can be filled with liquid through the forcing liquid supply duct. The gas volume will be above the liquid level of the supplied liquid volume because it is lighter. The gas volume can be pushed due to the continuously supplied forcing liquid and the liquid level raising. The gas volume will be discharged through a gas discharge conduit with a gas shut-off valve that is connected to the space of the receiving station with the gas that has remained behind in a section that can be found on top. The gas volume can, for example, be discharged to a pressure vessel through the gas discharge conduit. However, by preference, the gas volume can be dispelled to the gas line through a gas return line. The advantage of this is that very little or no gas will be wasted. In a preferred version of the receiving station a gas return line has been provided through a bypass with two gas shut-off valves around the gas shut-off valve in the gas line where the pig chamber is positioned in-between the two gas shut-off valves.

The underlying invention idea is that the gas that is under pressure in the launching or receiving station will be pushed by the supply of forcing liquid so that unsafe situations and emissions to the environment can be avoided with regard to both the launching station and the receiving station.

The invention also refers to a pig launching and receiving assembly for launching and receiving a pig in a gas line under high pressure comprising a launching station in accordance with one of the clauses 11-14 and/or a receiving station in accordance with one of the clauses 9-10. By preference, both the receiving station and the launching station have been equipped with a forcing liquid supply duct for dispelling a gas volume. The receiving and launching stations are, by preference, equipped with a gas discharge conduit.

An important advantage of the pig launching and receiving assembly in accordance with the invention is that its use entails few risks for operators. Gas no longer has to be blown off. The presence of forcing liquid that is under pressure is considerably less than the presence of gas that is under pressure. The safety regulations are less strict and staff can be less qualified.

Another advantage of the pig launching and receiving assembly is that the pig launching and receiving assembly has few moving parts. This means that the required maintenance to the pig launching and receiving assembly is low and the probability of failure small. The advantage with regard to the liquid pump is that the pushing away of the gas takes place with high efficiency and the gas is pumped away in a short period of time due to this. Another advantage is that the production of noise of the liquid pump is low. Moreover, it is a great advantage that existing systems for launching and receiving a pig can be easily converted without incurring costs to a pig launching and receiving assembly in accordance with the invention.

By preference, the gas shut-off valves in the launching and/or receiving opening are provided as ball valves. The ball valve comprises a ball set up to rotate with a cylindrical hole in the centre of the ball that is as large as the inner diameter of the launching and/or receiving opening. The ball valve is equipped in the gas line where the gas line can be closed or opened through the rotation of the ball.

The pig launching and receiving assembly in accordance with the invention is, in particular, applicable with regard to gas lines that run along the bottom of the sea. Great advantages may be obtained with the pig launching and receiving assembly in accordance with the invention with regard to the underwater scraping of a gas line. The underwater scraping of a gas line is, for example, required after connecting a gas line to a recently drilled gas well. When a gas line has been laid at the bottom of the sea and has been connected to the gas well, the gas line will be full of water. Said water must first be removed by using a pig before commissioning. The launching station in accordance with the invention is extremely suitable in this situation to provide a pig to the gas line underwater because it can be easily connected. The advantage is that the launching station can be connected to the gas line with only one connection. The launching station can be connected to the gas line with the launching opening through, by preference, a flange coupling. Before the launching station is connected to the gas line, the flange coupling can be easily closed using a cap. The connection work performed by divers can be significantly reduced due to the easy connection.

In a special version of the conduit to be laid, the launching station has already been equipped at the end of the conduit. This is an advantage, in particular, at great depths that are inaccessible to divers. The supply of forcing liquid and the operation of the gas shut-off valves can take place remotely from, for example, a drilling platform or a vessel.

By preference, the liquid pump of the launching station is provided on a vessel. The forcing liquid duct extends from the vessel to the underwater launching station. In principle, the gas shut-off valve of the gas well is closed. The pig can be pushed into the gas line by opening the gas shut-off valve in the launching opening and by supplying forcing liquid. The pig can be pushed through the gas line to the receiving station by subsequently opening the gas shut-off valve of the drilled well. The receiving station in accordance with the invention has, for example, been installed on a production platform with regard to this application.

By preference, the forcing liquid comprises a mixture of water and glycol or another hydrate inhibitor to ensure hydrate formation cannot take place within the launching/receiving station or the gas line.

The invention also refers to a working method for launching a pig in a gas line using a launching station comprising a pig chamber that can be connected to the gas line through a launching opening with a gas shut-off valve. The working method in accordance with the invention has the following steps. A pig is introduced in the pig chamber of a launching station during the first step. This can take place before or after connecting the launching station to the gas line. A forcing liquid is supplied through a forcing liquid supply duct during a next step until a forcing liquid pressure is achieved that is the same as the gas pressure in the gas line. Subsequently, the gas shut-off valve is opened in the launching opening after which the pig is pumped through the launching opening.

The invention also refers to a working method for receiving a pig from a gas line using a receiving station comprising a pig chamber that has been added through gas shut-off valves in the bypass around the shut-off valve of the gas line.

The working method for receiving comprises the following steps. The gas shut-off valves before and after the pig chamber are opened and a gas shut-off valve is closed in the gas line during a first step. The pig is passed on to the pig chamber through the receiving opening due to the gaseous medium. When the pig has been received in the pig chamber, the gas shut-off valve is opened in the main line and the gas shut-off valves before and after the pig chamber are closed.

Forcing liquid is supplied in a following step through a forcing liquid supply duct to dispel gas from the receiving station. By preference, the gas that remains in the receiving station is forced back to the gas line. The working method for launching comprises the following steps. The gas shut-off valves before and after the pig chamber are opened and a gas shut-off valve in the gas line is closed during the first step. The pig is passed on to the gas line through the launching opening due to the gaseous medium. When the pig has been launched in the gas line, the gas shut-off valve is opened in the main line and the gas shut-off valves before and after the pig chamber are closed.

Forcing liquid is supplied in a following step through a forcing liquid supply duct to dispel gas from the launching station. By preference, the gas that remains in the launching station is forced back to the gas line.

Further preferred versions are determined in the other clauses.

The invention will be further explained based on the enclosed drawings that show a practical version of the invention but may not be regarded as being restrictive, in which:

FIG. 5 provides a schematic representation of a pig launching and receiving assembly as is known from the state-of-the-art;

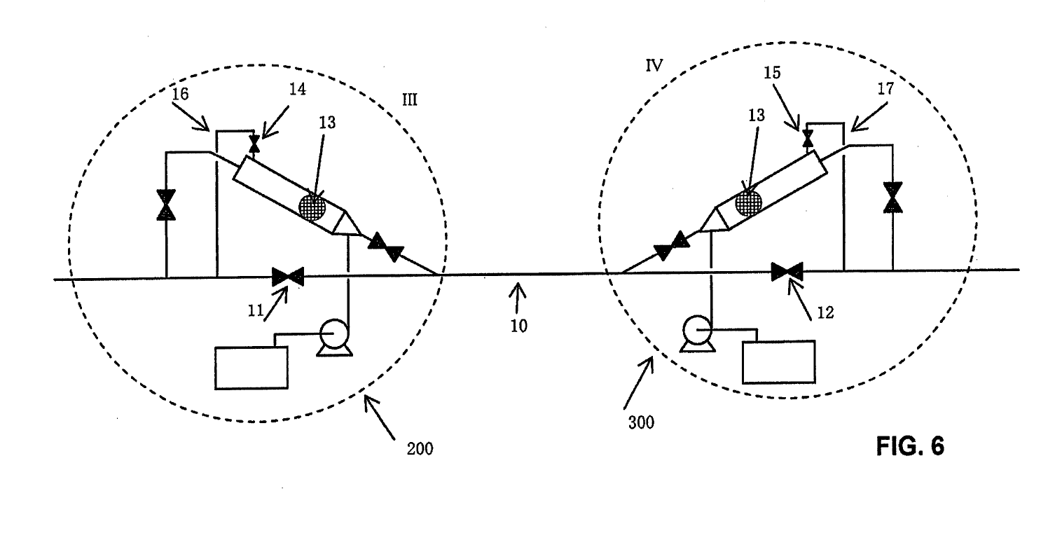

FIG. 6 provides a schematic representation of the pig launching and receiving assembly in accordance with the invention;

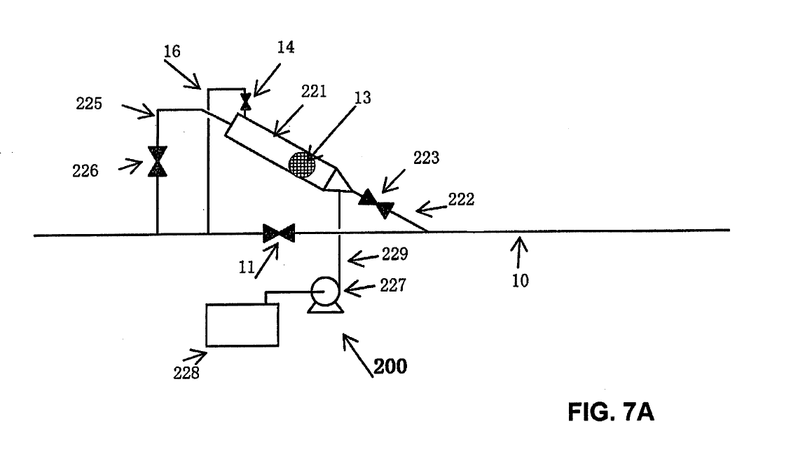

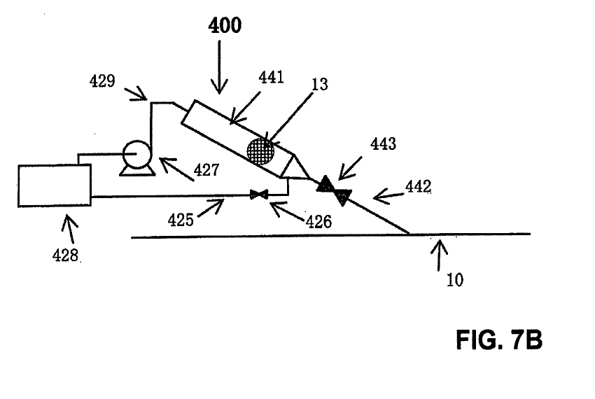

FIG. 7a provides a schematic representation of a launching station from FIG. 2;

FIG. 7b provides a schematic representation of a launching station with a forcing liquid as a launching medium;

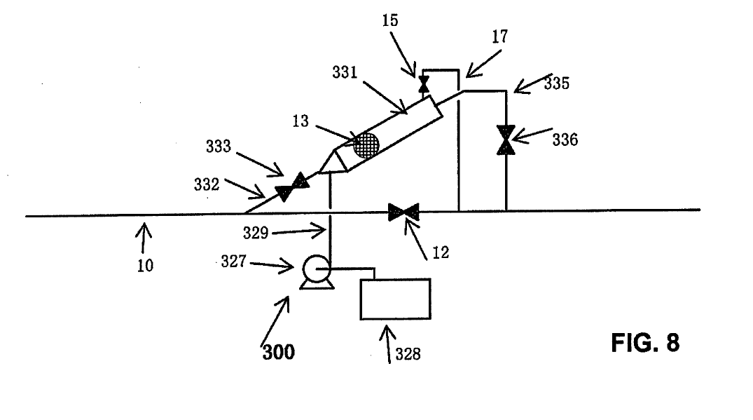

FIG. 8 provides a schematic representation of the receiving station from FIGS. 2; and

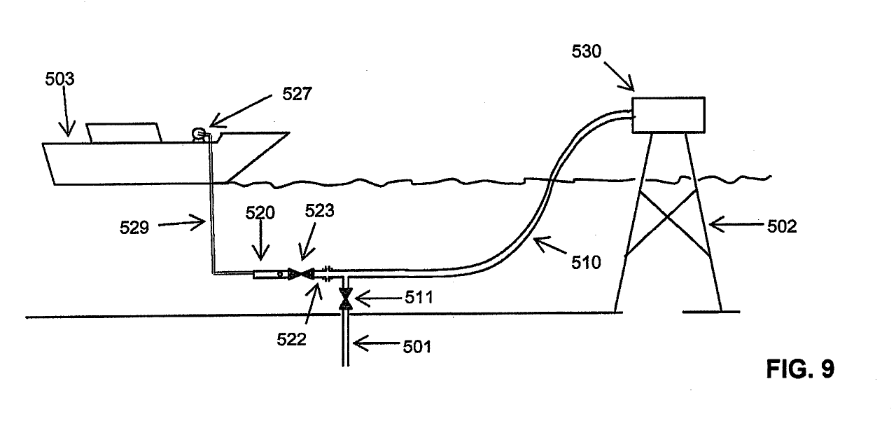

FIG. 9 provides a schematic representation of an underwater gas line with a launching station in accordance with the invention.

FIG. 5 shows a pig launching and receiving assembly from the state-of-the-art with a launching station 20 and a receiving station 30 that have been connected to a gas line 10. A first gas shut-off valve 11 and, downstream from this, a second gas shut-off valve 12 have been provided in the gas line 10. The gas shut-off valves can be operated when launching or receiving a pig 13. The pig 13 is shown in a pig chamber 21 of the launching station 20 and in a pig chamber 31 of the receiving station 30. The pig 13 is in a cylindrical space that acts as a pig chamber 21, 31. A launching opening 22 or receiving opening 32 has been provided on one side of the pig 13 in a pig chamber 21 or 31. A gas line 25, 35 has been provided on the opposite side of the pig 13 in the pig chamber 21 or 31.

Gas shut-off valves 23, 26 have been provided in the launching opening 22 and the gas line 25. The gaseous medium (that flows through the gas line as indicated by the arrow) will further flow through the gas line 10 through the bypass that is formed by the gas line 25, the pig chamber 21 and the launching opening 22 by closing the gas shut-off valve 11 in the gas line 10 and opening the gas shut-off valves 23, 26. This means that the pig 13 is launched and carried by the gas flow through the gas line.

The gas flow is diverted around the gas shut-off valve 12 in the gas line in a similar way as when the pig 13 is received in the receiving station 30. The bypass around the gas shut-off valve 12 is formed by the receiving opening 32 with inside a gas shut-off valve 33, the pig chamber 31 and the gas discharge conduit 35 with inside a gas shut-off valve 36. The pig 13 is carried along by the gas flow to the receiving station 30. When the pig 13 is in the pig chamber 31 of the receiving station 30, the gas shut-off valves 33, 36 are closed and the pig 13 can be removed from the pig chamber 31 after blowing off the remaining gas in the space in-between the gas shut-off valves 33, 36 through the gas venting facility 37.

As already described in the introduction, first the remaining gas in-between the gas shut-off valves 23, 26 will have to be blown off through gas venting facility 27 before inserting a pig 13 in the launching station 20.

FIG. 6 shows a pig launching and receiving assembly in accordance with the invention as a schematic representation. The pig launching and receiving assembly comprises a launching station 200 and a receiving station 300. The pig launching and receiving assembly is connected to a gas line 10 where a first gas shut-off valve 11 and a second gas shut-off valve 12 have been provided in the gas line 10 that can respectively be operated for launching and/or receiving a pig 13.

FIG. 7a shows in a magnified view the details of the launching station 200 from FIG. 2. The launching station 200 has a launching chamber 221 for the introduction of the pig 13. The pig chamber 221 is formed by a cylindrical space that is open on both sides. The pig 13 is inside the cylindrical space and is, therefore, set up in-between a bypass of the gas line 10 and a launching opening 222. A gas shut-off valve 223 can be found in the launching opening 222 and a gas shut-off valve 226 can be found in the bypass 225. A launching opening 222 has been provided on one side of the pig chamber 221 with a gas shut-off valve 223 and a gas supply line 225 has been provided at the other opening of the pig chamber with a gas shut-off valve 226. A forcing liquid supply line 229 has been provided in the pig chamber with inside a liquid pump 227 and a forcing liquid reservoir 228. The liquid pump 227 pumps forcing liquid from the forcing liquid reservoir 228 to the pig chamber 221.

The launching station 200 is included in a bypass around the gas shut-off valve 11 in the gas line 10. The bypass comprises the gas supply line 225, the pig chamber 221 and a launching opening 222. A gas shut-off valve 223 has been provided in the launching opening 222 and a gas shut-off valve 226 has been provided in the gas supply line 225. Launching the pig 13 from the pig chamber 221 of the launching station takes place during a number of successive steps where the gas is diverted from the gas line through the bypass so that the pig 13 can also be conveyed. When the pig 13 is no longer in the pig chamber 221 in-between both gas shut-off valves, gas shut-off valve 11 will again be opened in the gas line 10 and the gas shut-off valves 223, 226 will be closed. A gas volume, however, remains in the space of the pig chamber and the gas supply line 225 after launching the pig 13 that is under high pressure. In accordance with the invention, forcing liquid is supplied during a next step through the forcing liquid supply duct 229 which means that the gas that remained behind can be pushed from the space in the receiving station 200. The remaining gas is forced back through the gas return line 16 to the gas line 10 by opening the gas shut-off valve 14. Said gas return line 16 is installed in a section on top of the pig chamber and, by preference, at the highest point of the launching station, which, basically, means that all of the gas volume is dispelled from pig chamber 221 by the forcing liquid. Once all the gas has been dispelled, the forcing liquid is supplied back to the forcing liquid reservoir 228.

FIG. 7b shows in a magnified view the details of a launching station 400 that has a similar function as launching station 200 as shown in FIG. 2. The launching station 400 has a launching chamber 441 for the introduction of the pig 13. The pig chamber 441 is formed by a cylindrical space that is open on the crosscut ends. The pig 13 can be found inside the cylindrical space and is, therefore, set up in-between a launching opening 442 and a forcing liquid supply duct 429. A gas shut-off valve 443 has been provided in the launching opening 442. The launching station 400 is connected through the launching opening 442 in the flow connection with the gas line 10. The pig 13 in the pig chamber 441 is given access to the gas line 10 by opening the gas shut-off valve 443. High gas pressure dominates in the gas line 10 that can be, for example, 100-150 bar. This gas pressure must be overcome to press the pig 13 against this gas pressure in the gas line. The pig 13 is pressed out of the launching station 400 by supplying forcing liquid. The forcing liquid is supplied through the forcing liquid supply duct 429 that is connected to the pig chamber behind the pig. The forcing liquid under high pressure can be pumped from a forcing liquid reservoir 428 to the pig chamber 441 by using a liquid pump 427. When the liquid pressure behind the pig 13 is higher than the gas pressure at the front of the pig, the gas shut-off valve 443 in front of the pig will be opened and the pig will be launched into the gas line 10. When the pig 13 has left the launching station 400, the gas shut-off valve 443 will be closed. Subsequently, the forcing liquid can be returned through, for example, liquid duct 425 to the forcing liquid reservoir 428 by opening the shut-off valve 426. This means that the liquid pressure and the liquid level inside the launching station 400 drop. The representations in FIGS. 7a and 7b are schematic. The gas line is shown under the launching station in the schematic representation. The launching opening of the launching station is directed downwards in the schematic representation. However, in practice, it is advantageous to set up the launching station under the gas line and to provide the launching opening in a higher located section of the pig chamber. The launching station is, by preference, positioned fully under the gas line where the pig to be launched can be pushed upwards by using forcing liquid. Said setup is an advantage because, thus, nearly no forcing liquid needs to be introduced in the gas line when launching the pig. In practice, this setup is also advantageous because any remaining gas can be easily pushed through the launching opening to the gas line.

FIG. 8 shows in a magnified view the details of the receiving station 300 from FIG. 6. When the pig has been conveyed through the gas line 10, the pig 13 can be removed from the gas line 10 through the receiving station 300. The pig 13 is received in the pig chamber 331 of the receiving station for this. As is the case in the launching station, the pig chamber 331 is a cylindrical space that is open on both sides. There is a receiving opening with a gas shut-off valve 333 at one side of the pig chamber 331 and there is a gas discharge conduit 335 with a gas shut-off valve 336 on the other opening of the pig chamber. A forcing liquid supply line 329 has been provided with inside a liquid pump 327 and a forcing liquid reservoir 328 in the pig chamber. The liquid pump 327 pumps forcing liquid from the forcing liquid reservoir 328 to the pig chamber 331.

Receiving the pig 13 in the pig chamber 331 of the receiving station takes place in a number of consecutive steps. The receiving station 300 is included in a bypass around the gas shut-off valve 12 in the gas line 10. The bypass comprises the receiving opening 332, the pig chamber 331 and a gas discharge conduit 335. A gas shut-off valve 333 has been provided in the receiving opening 332 and a gas shut-off valve 336 has been provided in the gas discharge conduit 335. When the pig 13 is no longer in the pig chamber 331 in-between both gas shut-off valves, gas shut-off valve 12 will again be opened in the gas line 10 and the gas shut-off valves 333, 336 will be closed. A gas volume, however, remains in the space of the pig chamber and the gas discharge line 335 after receiving the pig 13 that is under high pressure. In accordance with the invention, forcing liquid is supplied during a next step through the forcing liquid supply duct 329 which means that the gas that remained behind can be pushed from the space in the receiving station 300. The remaining gas is forced back through the gas return line 17 to the gas line 10 by opening the gas shut-off valve 15. Said gas return line 17 is installed at the highest point of the receiving system after which the whole gas volume is dispelled from the pig chamber 331 by the forcing liquid. After all the gas has been dispelled from the pig chamber, the forcing liquid from the pig chamber is lead back to the forcing liquid reservoir 328.

FIG. 9 shows in a schematic representation a particular advantageous application of the pig launching and receiving assembly in accordance with the invention. The pig launching and receiving assembly is applied in a situation where a gas line 510 is under water. The gas line 510 has been laid at the bottom of the sea. The gas line 510 is connected to a drilled gas well 501. One end is connected to the gas well 501 through a system with a gas shut-off valve 511 in the flow connection and a receiving station 530 has been provided at the other end that has been positioned here on a production platform 502. The gas line 510 must, in particular, be cleaned using a pig when the gas line has been just laid and has not yet been commissioned. Water must be removed from the gas line before commissioning.

It is a great advantage to use a launching station 520 in accordance with the invention in this situation. By preference, the launching station 520 will have already been connected to the end of the gas line when laying the gas line 510. A forcing liquid supply duct 529 has been connected to the launching station 520 that extends from a pig chamber within the launching station to above the water surface. The forcing liquid supply duct 529 has, for example, a length of 100-300 m and a diameter of 25 mm (1 inch). A liquid pump 527 to push the forcing liquid to the pig chamber in the launching station 520 has been provided at the end of the forcing liquid supply duct 529 on board a vessel 503. As has already been described above making reference to FIG. 7b, a pig can be conveyed from the pig chamber of the launching station 520 through the launching opening 522 through the gas line 510 by operating the gas shut-off valve 511 and the gas shut-off valve 523. After launching a pig through the gas line 510, the gas shut-off valve 523 can be closed and the forcing liquid supply duct 529 can be uncoupled. The gas shut-off valve 511 and the gas shut-off valve 523 can, for example, be operated remotely from the vessel 503 or platform 530 using, for example, hydraulically operated gas shut-off valves. This has the advantage that divers are not required who would have to make the connections or carry out other work from scraping at a depth of, for example, 50-300 m.

Another advantage is that the launching station can be left behind at the bottom of the sea after the launching of the pig has been completed due to the easy and, therefore, also inexpensive construction of the launching station 520.

In addition to the versions shown in the figures, many variants are possible without stepping outside the protection scope of the clauses. It is, for example, possible to launch and receive a pig in a gas line without using gas shut-off valves in the gas line. The gas shut-off valves shown in the figures have, therefore, not been included in a bypass but directly in the gas line. In a variant, the forcing liquid supply duct can be connected to the pig chamber at multiple locations through a branching of a conduit. Multiple shut-off valves may have been provided in the branched conduit for a more effective control of the forcing liquid in the pig chamber. Forcing liquid can be supplied to the side of the launching opening and/or to the side opposite the launching opening of the pig chamber, as preferred, by operating the shut-off valves.

Thus a pig launching and receiving assembly and a working method for launching and receiving a pig has been provided in accordance with the invention where the safety when using the launching or receiving station is considerably increased by reliably and efficiently reducing the gas pressure.

The invention will, next, be further defined based on the following clauses:

1. Working method for the discharge of a remaining gas volume from a space of a gas line such as a pig chamber comprising the step of the discharge of the gas volume through a gas discharge conduit characterized in that the space is filled with a liquid through a forcing liquid supply duct wherein the gas volume is forced upwards to the gas discharge conduit.
2. Working method according to CLAUSE 1 wherein the gas volume is dispelled from the space to the gas line.
3. Working method according to CLAUSE 1 or 2 wherein the forcing liquid is lead back to the forcing liquid reservoir after pushing away the gas from the space, in particular, the pig chamber of a receiving station.
4. Working method according to one of the CLAUSES 1-3 wherein the space is a pig chamber of a receiving station for receiving a pig in a gas line where the pig can be connected to the gas line through a receiving opening with a gas shut-off valve, which comprises the following steps:

Connecting the receiving station to the gas line;

Closing a gas shut-off valve downstream in the gas line to the receiving station;

Opening the gas shut-off valve in the receiving opening;

Passing on the pig through the receiving opening to the pig chamber;

Closing the gas shut-off valve in the receiving opening;

Supplying forcing liquid through a forcing liquid supply duct to dispel gas from the receiving station.

5. Working method according to one of the CLAUSES 1-3 wherein the space is a pig chamber of a launching station for launching a pig in a gas line where the pig can be connected to the gas line through a launching opening with a gas shut-off valve, which comprises the following steps:

Introducing the pig in the pig chamber of a launching station;

Connecting the launching station to the gas line;

Supplying forcing liquid through a forcing liquid supply duct until a forcing liquid pressure has been achieved that is higher than the gas pressure in the gas line; and

Opening the gas shut-off valve in the launching opening where the pig is passed on through the launching opening due to the pressure difference.

6. Launching station (200) for the introduction of a pig (13) in a high pressure gas line (10) comprising a pig chamber (221) with a launching opening (222) with inside a gas shut-off valve (223) where the launching opening (222) can be connected to the gas line (10) characterized in that the launching station (200) is connected to a forcing liquid supply duct (229) with a liquid pump (227) for the supply of forcing liquid in such a way that the gas can be dispelled from the pig chamber.
7. Launching station (400) according to CLAUSE 6 wherein the launching station (400) on the side opposite to the launching opening (442) of the pig chamber (441) can be connected to a forcing liquid supply duct (429) with a liquid pump (428) for the supply of a forcing liquid in such a way that the pig (13) is pushed out of the pig chamber (441) through the launching opening (442) in the gas line.
8. Launching station according to CLAUSE 6 or 7 wherein the gas can be dispelled from the pig chamber through a gas return line (16) to the gas line.
9. Receiving station (300) for the removal of a pig (13) from a high pressure gas line (10) comprising a pig chamber (331) with a receiving opening (332) with inside a gas shut-off valve where the receiving opening can be connected to the gas line characteristic in that the receiving station (300) is connected to a forcing liquid supply duct (329) with a liquid pump (328) for the supply of forcing liquid in such a way that the gas can be dispelled from the pig chamber.
10. Receiving station (300) according to CLAUSE 9 wherein the gas can be dispelled from the pig chamber (331) through a gas return line (17) to the gas line (10).
11. Pig launching and receiving assembly (200,300) for launching and receiving a pig in a gas line under high pressure comprising a launching station in accordance with one of the clauses 1-3 and/or a receiving station in accordance with one of the clauses 4 or 5.
12. Pig launching and receiving assembly according to CLAUSE 11 wherein the gas shut-off valve in the launching opening and/or receiving opening is provided as a ball valve.
13. Pig launching and receiving assembly according to CLAUSE 11 or 12 wherein the liquid pump is provided on a vessel or platform.
14. Pig launching and receiving assembly according to one of the CLAUSES 11-13 wherein the forcing liquid comprises a hydrate inhibitor such as glycol.
15. Use of a pig launching and receiving assembly according to one of the CLAUSES 11-14 for the underwater scraping of a gas line.

The invention, therefore, refers to a launching station for the introduction of a pig in a high pressure gas line comprising a pig chamber with a launching opening with inside a gas shut-off valve where the launching opening can be connected to the gas line.

The invention also refers to a receiving station for the removal of a pig from a high pressure gas line comprising a pig chamber with a receiving opening with inside a gas shut-off valve where the receiving opening can be connected to the gas line. The receiving station and the launching station together form a pig launching and receiving assembly for launching and receiving a pig in a gas line under high pressure. Characteristic of the launching station or receiving station in accordance with the invention is that it is connected to a forcing liquid supply duct with a liquid pump for the supply of forcing liquid in such a way that the gas can be dispelled from the pig chamber. This all as shown in FIG. 2.

1. A liquid separating device for the separation of a liquid mixture comprising two liquids with a different density and possibly one or more solid substances, comprising:
a conduit for the separation therein of the liquids of a liquid mixture flowing through the conduit; and
a swirl device for generating swirls in the liquid mixture in such a way that two liquid flows are created wherein a first liquid flow will concentrate in the centre of the conduit and a second liquid flow will move concentrically around the first liquid flow and where the swirl device comprises a motor that has been positioned outside the conduit, a swirling element that is positioned in the conduit and a drive shaft that connects the motor and the swirling element with each other;
wherein the swirl device comprises at least one bearing system for a bearing connection of parts that rotate with respect to each other, and
wherein each bearing system of the swirl device is positioned outside the conduit.

2. The liquid separating device in according to claim 1 wherein the swirl device is removable and wherein an opening has been provided in a wall of the conduit for a passage of the swirling element.

3. The liquid separating device according to claim 1 wherein the conduit is at least partially transparent for a visual inspection of the separation in the conduit.

4. The liquid separating device according to claim 1 wherein the conduit comprises a main component in which the swirling element is set up and a secondary section to which a motor frame of the motor is connected.

5. The liquid separating device according to claim 4 wherein the motor frame and the secondary section are connected to each other through flanges.

6. The liquid separating device according to claim 5 wherein a seal has been installed in-between the flanges.

7. The liquid separating device according to claim 1 wherein a shaft seal has been positioned around the drive shaft.

8. The liquid separating device according to claim 1 wherein the swirling element has been fastened to the drive shaft in a releasable manner.

9. The liquid separating device according to claim 1 wherein at least a part of the drive shaft has been mounted on the motor in a releasable manner.

10. The liquid separating device according to claim 4 wherein the main section is conical and wherein the drive shaft is hollow and forms a discharge conduit for the discharge of the first liquid flow.

11. The liquid separating device according to claim 4 wherein the secondary section is aligned with the main section and wherein a supply conduit is connected with a bend to the main section.

12. The liquid separating device according to claim 10 wherein adjustable shut-off valves have been provided in a supply conduit and a discharge conduit.

13. The liquid separating device according to claim 10 wherein supply and discharge conduits have been provided to connect the main section to an existing conduit system.

14. Use of the liquid separating device for the separation of a liquid mixture comprising two liquids with different density wherein the use comprises the following steps:
connecting a liquid separating device in accordance with one of the preceding claims to an existing conduit system; and
separating two liquids.

15. Use according to claim 14 wherein at least one adjustable shut-off valve is used in a supply conduit for a main component for controlling the separation of liquid flows in the main section.

16. Working method for the replacement of a seal of a liquid separating device in accordance with claim 1 comprising the following steps:
removing the swirl device of the secondary section;
moving the swirl device to a position where the swirling element comes out of the conduit;
replacing a seal in-between the flanges or a seal around the drive shaft; and
repositioning the swirl device.

17. Working method according to claim 16 comprising the following steps:
removing the swirling element from the drive shaft and/or removing the drive shaft from the motor; and
repositioning the swirling element on the drive shaft and/or mounting the drive shaft to the motor.
